(19) United States
(12) Patent Application Publication
(10) Pub. No.: US 2003/0163639 A1
(43) Pub. Date: Aug. 28, 2003

(54) Sequential command processing mode in a disc drive using command queuing

(75) Inventors: Carol M. Baum, Longmont, CO (US); Marinko Bosnich, Berthoud, CO (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/172,528

(22) Filed: Jun. 14, 2002

Related U.S. Application Data
(60) Provisional application No. 60/360,084, filed on Feb. 25, 2002.

(51) Int. Cl. G06F 12/00

(52) U.S. Cl. 711/113; 711/167

(57) ABSTRACT

A method for managing queuing operations of a target device receiving commands issued by a host computer is disclosed. The target device is described as a disc drive having an ATA interface through which the commands are received. The interface includes queue for receiving and storing the commands. While in the queue, the commands are re-ordered for optimization. After being re-ordered, the disc drive checks the re-ordered arrangement of commands for overlap conditions. If, however, the disc drive detects a sequential command stream present in the commands transmitted from the host computer, the disc drive enters a sequential command processing mode wherein the commands of the sequential command stream forego queuing, and consequently, re-ordering and overlap checking, operations. Instead, these commands are performed in the order in which the commands are received by the disc drive.

### RELATED APPLICATIONS

This application claims benefit of priority of U.S. provisional application Serial No. 60/360,084, filed Feb. 25, 2002.

### FIELD OF THE INVENTION

This application relates generally to queuing commands sent from a host computer to target device and more particularly to operating the target device based on detection of a sequential command stream.

### BACKGROUND OF THE INVENTION

Various protocols govern the timing and structure of communications transmitted between a host computer and a disc drive. One such protocol is Advanced Technology Attachment (ATA) interface, which may be either Serial ATA (SATA) or Parallel (ATA). Using an ATA protocol, the host computer sends commands to a disc drive interface conforming to the ATA protocol being followed. This interface is generally referred to as an ATA interface. The commands direct the disc drive to access, i.e., write data to or read data from, one or more discs in the drive.

Commands are typically grouped together by the host computer in a command stream. Each command in a stream requests access to a group of sectors on a disc in the disc drive. A sequential command stream includes commands that request access to groups of sectors on a disc having sequentially adjacent physical block addresses (PBA's). In contrast, a random command stream includes commands that request access to groups of sectors having PBA's that are not sequentially adjacent.

In order to enhance performance, some disc drives following the ATA protocol implement command queuing procedures wherein commands are received by a queue of the ATA interface. The queue serves as a mechanism for storing the commands in the disc drive until the drive is ready to perform each command in turn. Based on the location where data is to be written to or read from on a disc, it is helpful to re-order the commands in the queue to optimize performance of the disc drive. Consequently, conventional disc drives typically re-order commands stored in the queue.

In order to maintain data integrity, the re-ordered commands are checked for overlap conditions. An overlap condition exists in a situation where a first command is assigned placement in the queue prior to a second command that the disc drive must perform in order to perform the first command. Re-ordering commands and checking for overlap conditions result in performance overhead that affects the efficiency at which data may be written to a disc. This performance overhead is generally outweighed by the benefit of re-ordering commands grouped together in a random command stream.

The benefit of re-ordering commands prior to performance is best illustrated using an example wherein a random command stream includes a first command that requests access to a first group of sectors on a first track on a disc, a second command that requests access to a second track on the disc and a third command that requests access to a second group of sectors on the first track having PBA's sequentially prior to the PBA's of the first group of sectors. Based on the real-time location of the transducer, the disc drive may re-order these commands in the queue such that the commands are performed in the following order: third, first and second. The drive then checks for overlap conditions, and if no overlap conditions exist, proceeds to perform these commands in the re-ordered sequence. The benefit of re-ordering random commands is realized in the interest of time saved in performing the commands versus time spent in re-ordering and overlap checking. The potential performance loss that would occur in performing the commands in the sequence defined prior to re-ordering is generally greater than time associated with the overall processing time of re-ordering and overlap checking.

Because commands contained in a sequential command stream are sent to the disc drive in sequential order with respect to the PBA's of the sectors to which the commands request access, re-ordering the commands and subsequently checking for overlap conditions are unnecessary processes. Indeed, the processing overhead of performing re-ordering and overlap checking operations adversely affects disc drive performance associated with executing commands of sequential command streams.

### SUMMARY OF THE INVENTION

Against this backdrop the present invention has been developed. An embodiment of the present invention is a process that disables command re-ordering operations of a target device operating within a queuing environment. The target device suspends re-ordering operations upon detection that commands issued by a host computer and received by the target device are included in a sequential command stream. Prior to such detection, the target device is operated in a normal command processing mode wherein commands are received by the device and placed in a queue. While stored in the queue, the commands are re-ordered and subsequently tested for overlap conditions.

The process of the present invention evaluates each command issued by the host computer to identify a set of commands that request access to sequentially adjacent groups of sectors. This set of commands is referred to as a sequential command stream. If a sequential command stream is detected, the target device is operated in a sequential command processing mode wherein commands in the sequential command stream are not re-ordered and, consequently, not checked for overlap conditions upon receipt into the target device. Rather, the commands are performed by the target device in the order in which the commands are issued by the host computer and therefore received by the target device. In accordance with an embodiment, the target device is a disc drive having an ATA interface through which the commands issued by the host computer are received.

Embodiments of the invention may be implemented, for example, as a computer-readable program storage device which tangibly embodies a program of instructions executable by a computer system to control queuing operations in a target device. These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a functional block diagram generally showing the main functional components used to control the disc drive of FIG. 1 including an interface having a queue and a queue manager in accordance with an embodiment of the present invention.

FIG. 3 is a flow diagram that illustrates operations for managing queuing operations of a target device receiving commands issued by a host computer in accordance with an embodiment of the present invention.

FIG. 4 is a flow diagram that illustrates operations for detecting a sequential command stream in a stream of commands issued by a host computer in accordance with an embodiment of the present invention.

FIG. 5 is a flow diagram that illustrates operations for managing reception and performance of a sequential command stream in accordance with an embodiment of the present invention.

FIG. 6 is a flow diagram that illustrates operations for managing reception and performance of a random command stream in accordance with an embodiment of the present invention.

### DETAILED DESCRIPTION

The present invention and its various embodiments are described in detail below with reference to the figures. When referring to the figures, like structures and elements shown throughout are indicated with like reference numerals.

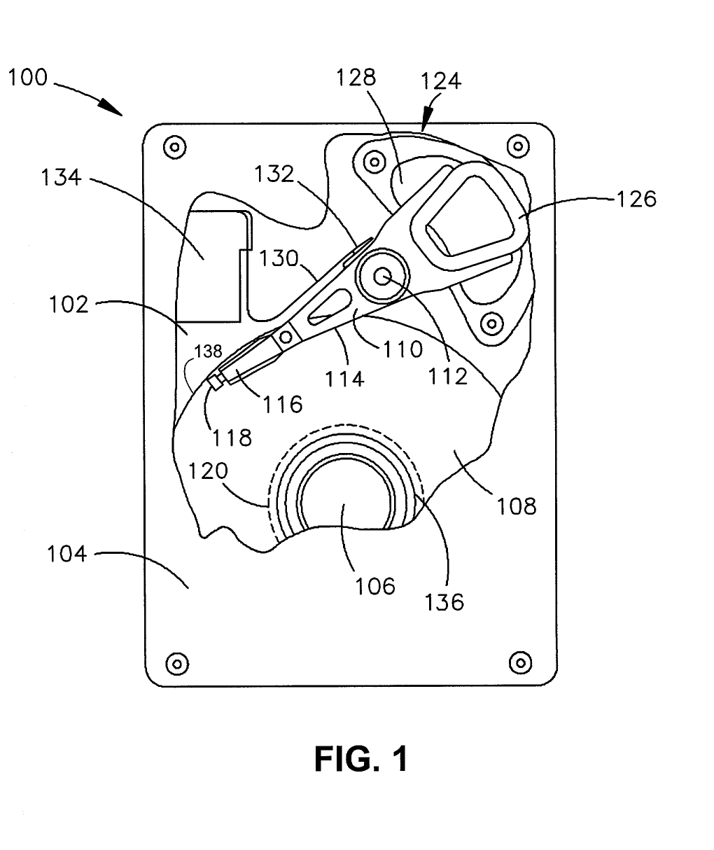

A disc drive 100 constructed in accordance with an embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive 100 in a conventional manner. The components include a spindle motor 106 which rotates one or more discs 108 at a constant high speed. Information is written to and read from tracks on the discs 108 through the use of an actuator assembly 110, which rotates about a bearing shaft assembly 112 positioned adjacent to the discs 108. The actuator assembly 110 includes a plurality of actuator arms 114 which extend towards the discs 108, with one or more flexures 116 extending from each of the actuator arms 114. Mounted at the distal end of each of the flexures 116 is a read/write head 118 which includes an air bearing slider enabling the read/write head 118 to fly in close proximity above the corresponding surface of the associated disc 108.

The spindle motor 106 is typically de-energized when the disc drive 100 is not in use for extended periods of time. In accordance with one embodiment of the present invention, the read/write heads 118 are moved over park, or landing, zones 120 near the inner diameter 136 of the discs 108 when the drive motor is de-energized. The read/write heads 118 may be secured over the landing zones 120 through the use of an actuator latch arrangement, which prevents inadvertent rotation of the actuator assembly 110 when the heads 118 are parked. Although the landing zone 120 is shown in FIG. 1 as located in close proximity to the inner diameter 136 of the discs 108, a landing zone 120 may also be located in close proximity to an outer diameter 138 of the discs 108. Furthermore, a landing zone 120 may be located on any portion of the discs 108 between the outer diameter 138 and the inner diameter 136 of the discs 108. Alternatively, the read/write heads 118 may be removed from the surface of the discs 108 by load/unload ramps positioned in close proximity to the outer diameter 138 when the drive motor is de-energized. As such, the read/write heads 118 may be secured by the ramps to prevent inadvertent rotation of the actuator assembly 110 when the discs 108 are spinning at a velocity insufficient to maintain an air bearing between the sliders and the discs 108. The heads 118 are maintained on the ramps in the park position through the use of an actuator latch arrangement, which prevents inadvertent rotation of the actuator arms 114 when the heads are parked. This latch arrangement is typically a magnetic latch which magnetically holds the actuator against a stop.

The radial position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112 and the heads 118 are caused to move across the surfaces of the discs 108.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and for amplifying read signals generated by the heads 118 during a read operation. The flex assembly terminates at a flex bracket 134 for communication through the base 102 to a disc drive printed circuit board (not shown) mounted to the bottom side of the disc drive 100.

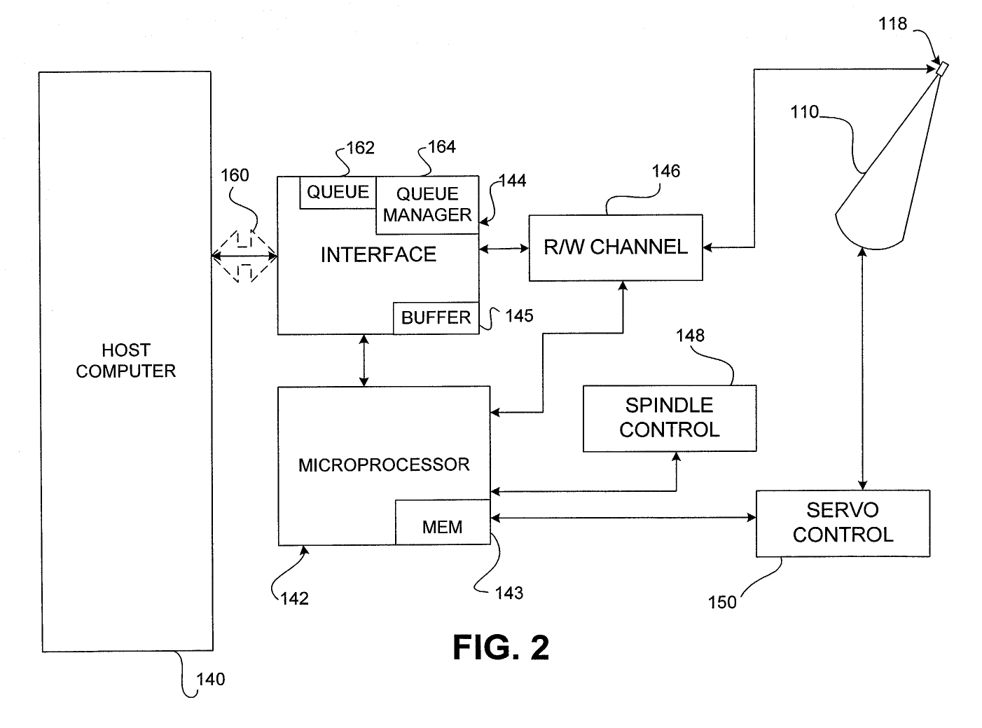

Referring now to FIG. 2, shown therein is a functional block diagram of the disc drive 100 of FIG. 1 generally showing the main functional circuits which are resident on the disc drive printed circuit board and used to control the operation of the disc drive 100. The disc drive 100 is shown in FIG. 2 to be operably connected to a host computer 140 in which the disc drive 100 is mounted in a conventional manner. Control communication paths are provided between the host computer 140 and the disc drive 100 using a bus 160 coupled between the host computer 140 and a disc drive interface 144. A bus (such as 160) is generally defined as a path carrying data between two or more devices. The bus 160, which is used to communicate data and control lines between the host computer 140 and the disc drive 100, also connects the host computer 140 to other devices that communicate with the host computer 140. The bus 160 is shown in dashed arrows because the bus 160 is not in and of itself a single physical object, but rather a collection of cabling/wiring that, taken together, makes up a communication channel between the host computer 140 and the disc drive 100.

Various industry standards provide specifications that govern the structure and timing of communications between two devices over the bus 160, including, without limitation, Serial Advanced Technology Attachment (SATA), Parallel ATA (PATA), Fibre Channel Arbitrated Loop (FC-AL), Small Computer System Interface (SCSI) and Serial Attached SCSI. In accordance with an embodiment, and not by means of limitation, the industry standard applied herein is an ATA standard—SATA or PATA. SATA and PATA, as well as the other industry standards noted above, are widely known and therefore not described in detail herein.

Commands issued by the host for performance by the disc drive 100 are carried to the drive 100 over the bus 160. These commands may be contained in either sequential command streams or random command streams. After the disc drive 100 receives the commands, the disc drive 100 may operate in one of command processing modes—a normal command processing mode or a sequential command processing mode—in accordance with an embodiment of the present invention.

In the normal command processing mode, commands are received by the disc drive interface 144 and initially sent to a queue 162. The queue 162 is a mechanism for storing commands in the disc drive interface 144 until the drive 100 is ready to execute each command in turn. While stored in the queue 162, the commands are re-ordered to optimize drive performance. The commands are also checked for overlap conditions. In the sequential command processing mode, commands received by the interface 144 by-pass the queue 162 and are performed in the order received. As such, the commands are not re-ordered. Consequently, the commands are not checked for overlap conditions.

The queue 162 is managed by a queue manager 164. The queue 162 and the queue manager 164 are components of disc drive firmware in accordance with an embodiment of the present invention. Alternatively, the queue 162 and the queue manager 164 may be hardware components.

The queue manager 164 administers re-ordering and overlap checking processes of commands contained in the queue 162. The queue manager 164 also controls access to the queue 162 by the host computer 140. To accomplish this, the queue manager 164 directs the interface to either hold or release the bus 160. If the bus 160 is held, control communications are sent to the host computer 140 by the interface 144 requesting the host computer 140 to refrain from sending commands over the bus 160. Thus, the host computer 140 is precluded from transmitting commands to any device coupled to the bus 160. Access to the queue 162 by the host computer 140 is therefore precluded. Once held, the bus 160 may be released by the disc drive 100 sending control communications to the host computer 140 that request the host computer 140 to resume sending commands to the disc drive 100. Access to the queue 162 by the host computer 140 is therefore enabled.

The queue manager 164 also monitors each command stream transmitted by the host computer 140 to evaluate whether the command stream is sequential or random in accordance with an embodiment of the present invention. A sequential command stream includes commands that request access to groups of sectors on a disc having sequentially adjacent physical block addresses (PBA's). In contrast, a random command stream includes commands that request access to groups of sectors having PBA's that are not sequentially adjacent. If the queue manager 162 detects a sequential command stream, the command processing mode of the disc drive 100 is changed to the sequential command processing mode. If the queue manager 162 does not detect a sequential command stream, the command processing mode of the disc drive 100 is maintained as the normal command processing mode wherein commands are received into the queue 162, reordered and checked for overlap conditions.

A microprocessor 142 is operably connected to the interface 144 via various control and data lines. The microprocessor 142 provides top-level communication and control for the disc drive 100 in conjunction with programming for the microprocessor 142. The programming is typically stored in a microprocessor memory (MEM) 143. The MEM 143 may include random access memory (RAM), read only memory (ROM) and other sources of resident memory for the microprocessor 142. Additionally, the microprocessor 142 provides control signals for a spindle control module 148 and a servo control module 150. The spindle control module 148 is responsible for spinning the discs 108 at a speed (rpm) set by the microprocessor 142. The servo control module 150 controls movement of the activator arms 114 relative to the discs 108 based on commands issued by the microprocessor 142 and positioning signals fed back to the module 150 from the transducers 118.

Data is transferred between the host computer 140 and the disc drive 100 by way of the disc drive interface 144, which includes a buffer 145 to facilitate high speed data transfer between the host computer 140 and the disc drive 100. Data to be written to the disc drive 100 is thus passed from the host computer 140 to the buffer 145 and then to a read/write channel 146, which encodes and serializes the data and provides the requisite write current signals to the heads 118. To retrieve data that has been previously stored by the disc drive 100, read signals are generated by the heads 118 and provided to the read/write channel 146. The read/write channel 146 then outputs the retrieved data to the buffer 145 for subsequent transfer to the host computer 140.

Embodiments of the present invention may be implemented either through hardware, i.e., logic devices, or as a computer-readable program storage device which tangibly embodies a program of instructions executable by a computer system for managing queuing operations of a target device, e.g., disc drive 100, receiving commands issued by a host computer 140. As such, the logical operations of the various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

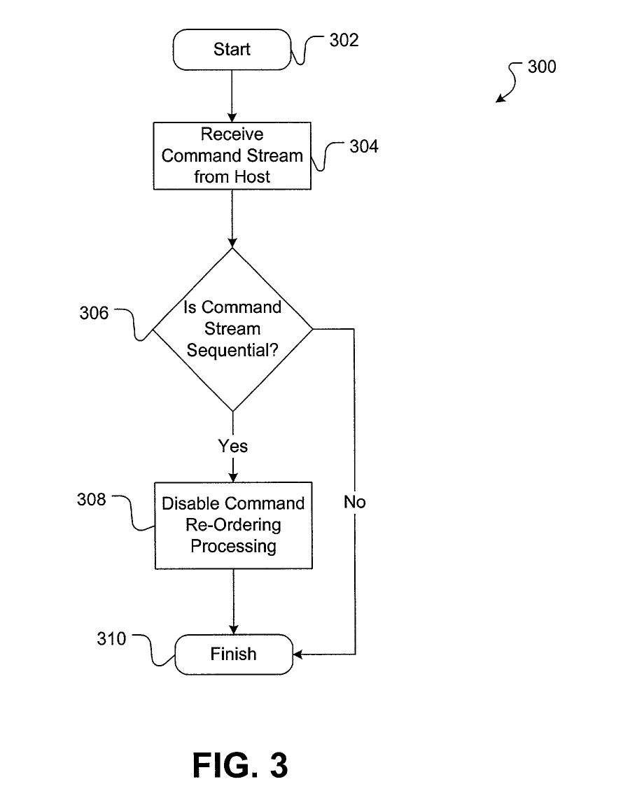

FIG. 3 illustrates operations of a control process 300 for managing queuing operations of a target device receiving commands issued by a host computer 140 in accordance with an embodiment of the present invention. The target device is described below as the disc drive 100 in accordance with an exemplary embodiment of the present invention. It should be appreciated, however, the target device may be any device operable to communicate with the host computer 140. The control process 300 may be implemented in disc drive firmware or using various hardware components, or a combination of both hardware and firmware.

The control process 300 comprises an operation flow beginning with a start operation 302 and concluding with a terminate operation 312. The control process 300 is illustrated below as managing queuing operations for a single command stream in accordance with an exemplary embodiment of the present invention. However, the control process 300 may be re-initiated following the terminate operation 310 to manage queuing operations for any number of command streams. The control process 300 is initiated at the start operation 302 after the host computer 144 issues multiple commands to be performed by the disc drive 100. From the start operation 302, the operation flow passes to a receive command operation 304.

The receive command operation 304 begins receiving the commands issued by the host computer 140 as the drive 100 operates in the normal command processing mode. From the receive command operation 304, the operation flow passes to a query operation 306. The query operation 306 evaluates the commands to detect a sequential command stream therein. The query operation 306 branches the operation flow to a change command processing mode operation 308 if the query operation 306 determines that the command stream is a sequential command stream. The command stream therefore includes commands that request access to groups of sectors on a disc having sequentially adjacent physical block addresses (PBA's). The change command processing mode operation 308 changes the command processing mode of the disc drive 100 from normal to sequential. In the sequential command processing mode, commands of the command stream being received forego re-ordering and overlap condition checking processes. The commands are thus performed in the order received by the disc drive 100.

The query operation 306 branches the operation flow to the terminate operation 310 if the query operation 306 does not detect a sequential command stream present in the commands issued by the host computer 140. Each command received by the disc drive 100 therefore requests access to groups of sectors having PBA's that are not sequentially adjacent with one another. As such, these commands may be referred to collectively as a random command stream. The operation flow concludes at the terminate operation 310 and the disc drive 100 maintains normal queuing operations as the drive 100 operates in the normal command processing operating mode. During the normal command processing mode, commands received by the disc drive 100 are queued, re-ordered while being queued and subsequently checked for overlap conditions prior to being performed by the disc drive 100.

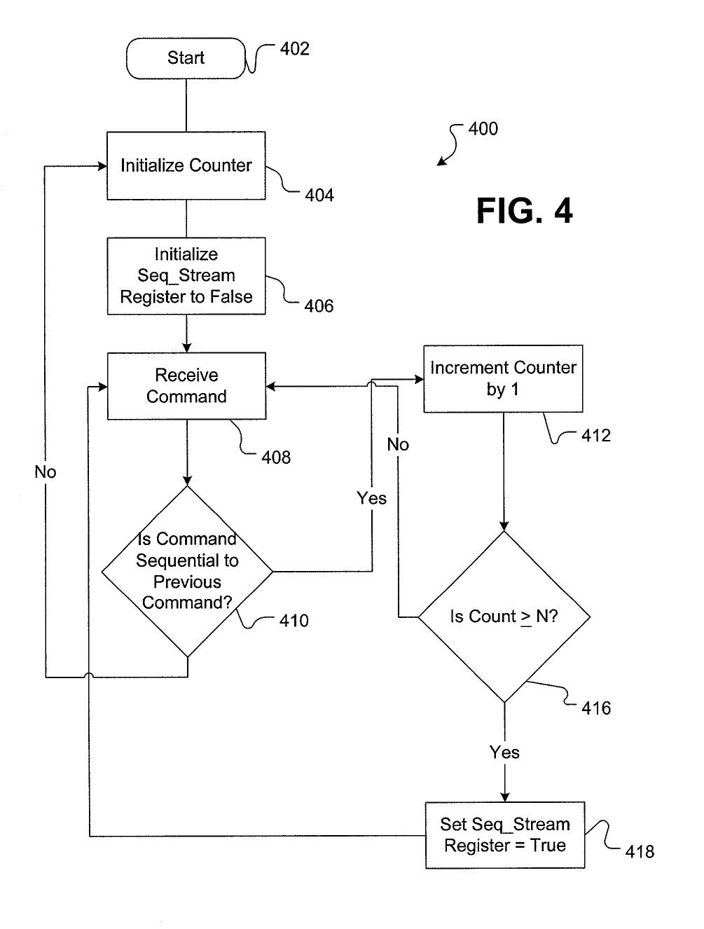

FIG. 4 illustrates operations of a process 400 for detecting a sequential command stream present in commands issued by the host computer 140 in accordance with an embodiment of the present invention. Like the control process 300, the detection process 400 may be implemented in disc drive firmware or using various hardware components, or a combination of both hardware and firmware. The detection process 400 comprises an operation flow beginning with a start operation 402 and concluding with a terminate operation 420.

From the start operation 402, the operation flow passes to an initialize counter operation 404. The initialize counter operation 404 initializes a counter which will be used by the detection process 400 to detect a sequential command stream present in the commands issued by the host computer 140. Once initialized, the count of the counter is zero. From the initialize counter operation 404, the operation flow passes to an initialize register operation 406.

The initialize register operation 406 initializes a sequential stream (“Seq_Stream”) register to a default setting of “false.” The disc drive 100 operates in the normal command processing mode while the sequential stream register is set to “false.” As soon as the sequential stream register is set to “true,” the disc drive 100 begins operating in the sequential command processing mode until the sequential stream register goes back to “false.” From the initialize register operation 406, the operation flow passes to a receive command operation 408.

The receive command operation 408 receives each command transmitted over the bus 160 in the order in which the commands are issued by the host computer 140. After the first command issued by the host computer 140 is received, the operation flow passes from the receive command operation 408 to a first query operation 410. The first query operation 410 determines whether the received command is sequential to the previously received command with respect to the physical block addresses of the commands. In accordance with an embodiment, if the first query operation 410 determines that the command is not sequential to the previously received command, the operation flow passes back to the initialize counter operation 404 and continues to the first query operation 410 until a command sequential to a previous command is received by the receive command operation 410. In these circumstances, the commands are identified to be part of a random command stream, and therefore, the disc drive 100 continues to operate in the normal command processing mode. Once a command sequential to a previous command is received, the operation flow passes to an increment counter operation 412. The increment counter operation 412 increments the counter by a count of one. From the increment counter operation 412, the operation flow passes to a second query operation 416.

The second query operation 416 compares the count of the counter against a predetermined count set to distinguish between random command streams having commands coincidentally requesting access to groups of sectors with sequential PBA's. In accordance with an embodiment, the predetermined count should be set to a number greater than a number representing a maximum number of commands in a random command stream that would request access to groups of sectors having sequentially adjacent PBA's. If the count of the counter is not equal to the predetermined count, the second query operation 416 branches the operation flow to the command receive operation 408.

The command receive operation 408 receives the next command issued by the host computer 140 and the operation flow thereafter continues as previously described. If the count of the counter is greater than or equal to the predetermined count, the second query operation 416 branches the operation flow to the set register operation 418. The set register operation 418 sets the Seq_Stream register to “true” and the disc drive 100 is directed to change from the normal command processing mode to the sequential command processing mode. From the set register operation 418, the operation flow passes to the receive command operation 408. The operation flow thereafter continues as previously described without termination until the host computer 140 and the disc drive 100 cease to communicate with one another.

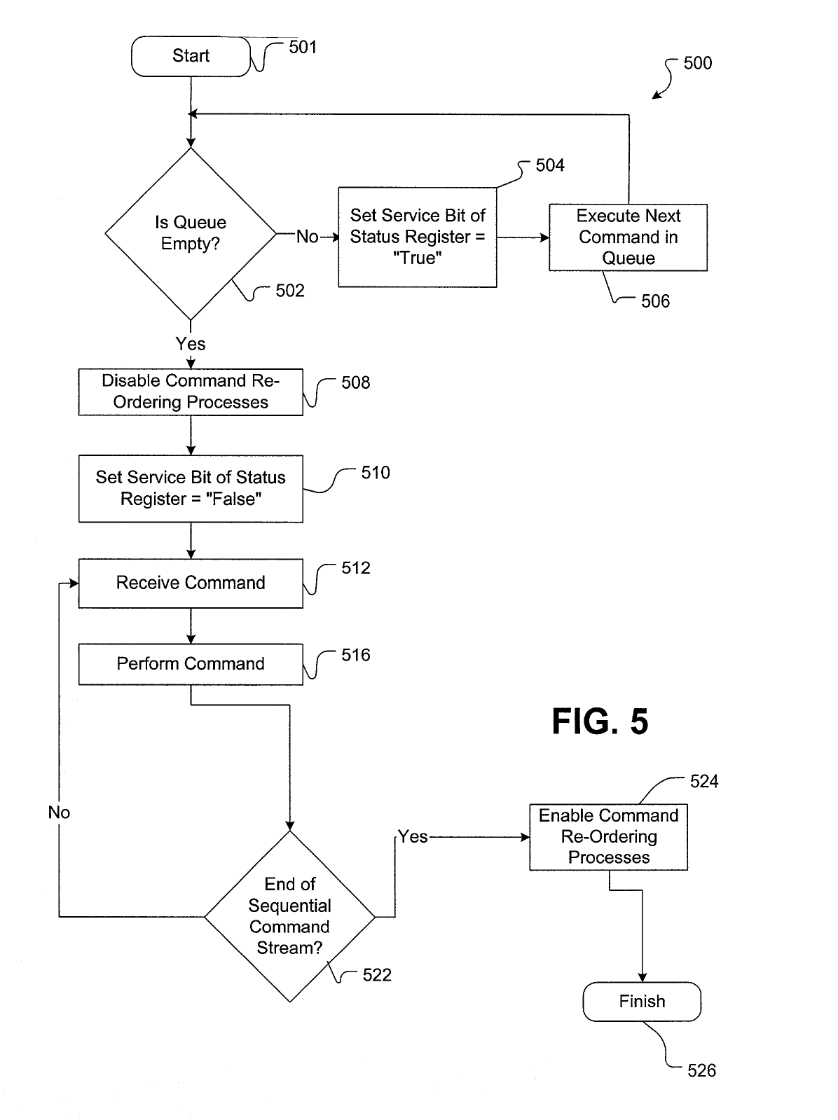

Referring now to FIG. 5, a process 500 of operations performed during a sequential command processing mode are shown in accordance with an embodiment of the present invention. For reference, the process 500 of FIG. 5 is referred to herein as a “sequential streaming” process. The sequential streaming process 500 may be implemented in disc drive firmware or using various hardware components, or a combination of both hardware and firmware. Indeed, the sequential streaming process 500 is illustrated below as logical operations performed by disc drive firmware as the firmware monitors and controls operation of the queue 162. The sequential command processing mode 500 comprises an operation flow beginning with a start operation 501 and concluding with a terminate operation 526. The start operation 501 is initiated as the state of the Seq_Stream register goes “true.” From the start operation 501, the operation flow passes to a first query operation 502. The first query operation examines the queue 162 to render a determination on whether the queue 162 is “empty.” The queue 162 is deemed “empty” if all commands previously stored in the queue 162 have been executed. If the queue 162 is not empty, the first query operation 502 branches the operation flow to a first request service operation 504.

At the completion of the present command, the first request service operation 504 sets the service bit of the status register on the bus 160 to the host computer 140. If the service bit of the status register is set, or “true,” the host computer 140 is directed to either (1) transmit data that is to be written to a disc 108, or (2) retrieve data that has been stored on a disc 108 and moved to the buffer 145 by the disc drive 100, based on whether the command is a read or a write command. If the service bit is “true,” the host computer 140 therefore transfers or receives data based on the type of command. During this time, the host computer 140 is precluded from issuing any new read or write commands to the disc drive 100. Thus, initiation of new commands is paused while the service bit is “true.” From the first request service operation 504, the operation flow passes to a first execute command operation 506.

The first execute command operation 506 performs the next command in the queue 162 and the operation flow subsequently passes back to the first query operation 502. The first execute command operation 506 is enabled because the service bit of the status register sent to the host computer 140 by the first request service operation 504 is set to “true.” The host computer 140 is therefore requested to either send data to the disc drive 100 or retrieve data from the disc drive 100. Regardless, however, the first request service operation 504 prepares the host computer 140 for a data transfer and the first execute operation 506 actually implements the data transfer. The operation flow continues in a loop between the first query operation 502 and the first execute command operation 506 until the queue 162 is empty. Once the queue 162 is empty, the operation flow passes to a disable re-ordering operation 508.

The disable re-ordering operation 508 controls access over the queue 162 such that the commands issued by the host computer 140 are not re-ordered, but rather performed as received by the disc drive interface 144. Besides placement of the commands in the queue 162, the disable re-ordering operation 508 effectively eliminates all queuing operations that the disc drive 100 would perform while operating in the normal command processing mode. The disable re-ordering operation 508 therefore places the disc drive 100 in a sequential command processing mode. From the disable re-ordering operation 508, the operation flow passes to a request command operation 510.

The request command operation 510 sets the service bit of the status register on the bus 60 to “false.” As such, the service bit of the status register is not set during the status phase of he last command in the queue 162. If the service bit of the status register is not set, or “false,” he host computer 140 is directed to issue the next new command. From the request command operation 510, the operation flow passes to a receive command operation 512. The receive command operation 512 receives commands one at a time issued by the host computer 140. Once a command is received, the operation flow passes from the receive command operation 512 to a perform command operation 516.

The perform command operation 516 performs each command received by the disc drive 100 one at a time after each command is received by the receive command operation 512. Once a command is performed, the operation flow passes from the perform command operation 516 to a second query operation 522.

The second query operation 522 determines whether all commands of the detected sequential command stream have been received by the disc drive 100. If all commands of the detected sequential command stream have not been received by the disc drive 100, the second query operation 522 branches the operation flow back to the receive command operation 512. The receive command operation 512 then receives the next command issued by the host computer 140. The operation flow continues looping between the second execute command operation 516 and the second query operation 522 until the last command of the detected sequential command stream is performed. Once the last command of the detected sequential command stream is performed by the disc drive 100, the operation flow passes to an enable reordering operation 524.

The enable re-ordering operation 524 controls the queue 162 such that commands issued by the host computer 140 and received by the disc drive 100 are re-ordered prior to being performed by the disc drive 100. The disc drive 100 is therefore operated in the normal command processing mode following the enable re-ordering operation 524. Following the enable re-ordering operation 524, the operation flow of the sequential streaming process 500 concludes at the terminate operation 526.

In accordance with an embodiment, the second query operation 522 makes the determination on whether all commands of the detected sequential command stream have been received by the disc drive 100 based on the state of the Seq_Stream register. So long as the state of the Seq_Stream register is “true,” the second query operation 522 will branch the operation flow back to the command receive operation 512. Once the state of the Seq_Stream register goes “false,” the second query operation 522 branches the operation flow to the enable re-ordering operation 524.

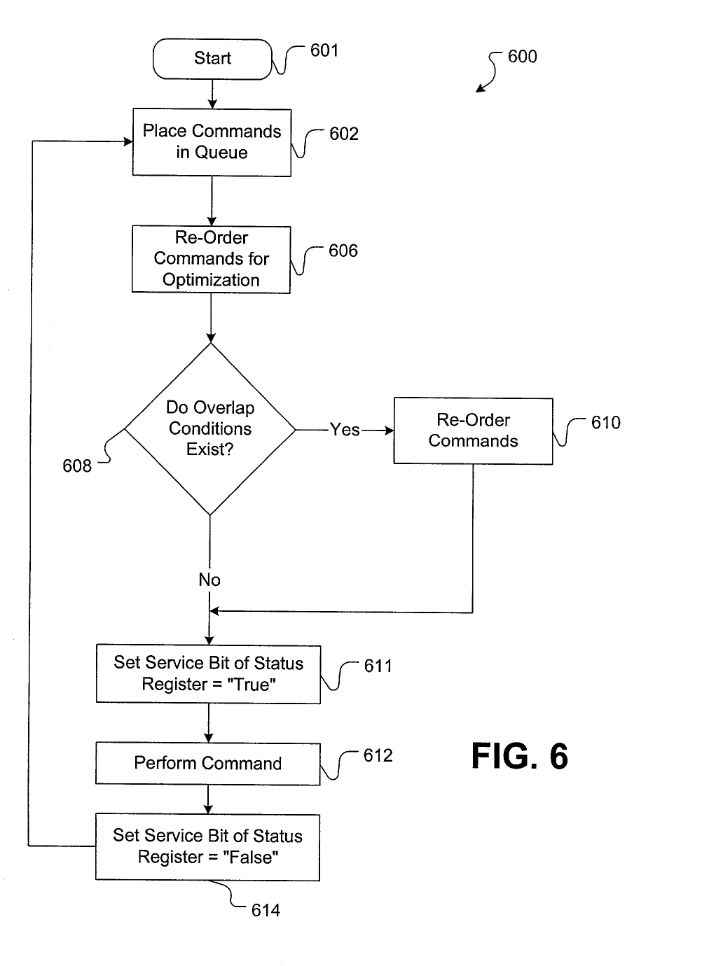

Referring now to FIG. 6, a process 600 of operations performed during a normal command processing mode are shown in accordance with an embodiment of the present invention. For reference, the procedure 600 of FIG. 6 is referred to herein as a “normal command processing” procedure. Like the sequential streaming process 500, the normal command processing procedure 600 may be implemented in disc drive firmware or using various hardware components, or a combination of both hardware and firmware. The normal command processing procedure 600 is illustrated below as logical operations performed by disc drive firmware as the firmware monitors and controls operation of a queue 162.

The normal command processing procedure 600 is performed by an operation flow beginning with a start operation 601 and continuing until a sequential command stream is detected, which in accordance with an embodiment, occurs when the Seq_Stream register goes “true.” Because the normal command processing mode is the default command processing mode for a disc drive 100, the start operation 601 is initiated upon receipt of a command by the disc drive 100. Because the disc drive 100 operates continuously in the normal command processing mode until a sequential command stream is detected, the normal command processing procedure 600 is illustrated with reference to a single random command stream in accordance with an exemplary embodiment of the present invention. It should be appreciated, however, that the normal command processing procedure 600 is a continuous process that may be paused while the state of the Seq_Stream register is “true.” At all other times, the normal command processing procedure 600 is performed for each random command stream transmitted to the disc drive 100 by the host computer 140.

From the start operation 601, the operation flow passes to a queue operation 602. The queue operation 602 places commands in the queue 162 as the commands are being received by the disc drive 100. In accordance with an embodiment, the queue operation 602 may receive any number of commands until the queue is full. From the queue operation 602, the operation flow passes to a re-order operation 606.

The re-order operation 606 arranges the commands in the queue 162 such that the commands are performed in an order based on the location to which each command requests access on a disc 108 respective of the real-time read/write head 118 location. The re-order operation 606 is best illustrated using an example wherein a set of commands stored in the queue 162 include a first command that requests access to a first group of sectors on a first track on a disc 108, a second command that requests access to a second track on the disc 108 and a third command that requests access to a second group of sectors on the first track having PBA's sequentially prior to the PBA's of the first group of sectors. Based on the location of the read/write head 118, the re-order operation 606 may arrange these commands in the queue 162 such that the commands are performed in the following order: third, first and second.

From the re-order operation 606, the operation flow passes to a query operation 608. The query operation 608 checks arrangement of the commands in the queue 162 for overlap conditions. If no overlap conditions exist, the query operation 608 passes directly to a request service command operation 611.

The request service command operation 611 sets the service bit of the status register on the bus 160 to “true.” Because the service bit of the status register is set, or “true,” the host computer 140 is notified that it is to either (1) transmit data that is to be written to a disc 108, or (2) retrieve data that has been stored a disc 108 and moved to the buffer 145 by the disc drive 100, based on whether the received command is a read or a write command. During this time, the host computer 140 is precluded from issuing any new read or write commands to the disc drive 100. Thus, initiation of new commands is paused while the service bit is “true.” From the request service command operation 611, the operation flow passes to an execute command operation 612.

The execute command operation 612 begins performing the commands in the re-ordered sequence, beginning with the first command. The execute command operation 612 is enabled because the service bit of the status register is currently set to “true.” The host computer 140 is therefore requested to either send data to the disc drive 100 or retrieve data from the disc drive 100 based whether the first command is a read or a write command. Regardless, however, the request service command operation 611 prepares the host computer 140 for a data transfer and the execute command operation 612 actually implements the data transfer. From the execute command operation 612, the operation flow passes to a request command operation 614.

The request command operation 614 sets the service bit of the status register on the bus 160 to “false.” If the service bit of the status register is not set, or “false,” the host computer 140 is directed to issue the next command. From the request command operation 614, the operation flow passes back to the queue operation 602 and the operation flow continues as previously described until the Seq_Stream register goes “true.”

If, however, the query operation 608 detects an overlap condition, the query operation 608 branches the operation flow to a second re-order operation 610 where the commands are again reordered, but this time in a manner such that no overlap conditions exist. Following the second reorder operation 610, the operation flow passes to the request service command operation 611 and the operation flow continues as described above.

In summary, the present invention may be viewed as a method (such as in operation 300) for managing queuing operations of a target device (such as 100) in accordance with an embodiment of the present invention. The target device receives commands issued by a host computer (such as 140) and placing the commands in a queue (such as 162) for arrangement of an order in which the commands are to be performed by the target device. In this embodiment, the method includes evaluating (such as in operation 306) a stream of commands to determine whether the commands in the stream request access to groups of sectors having sequentially adjacent physical block addresses. The method also includes operating (such as in operation 500) the target device in a sequential command processing mode wherein if the commands in the stream request access to groups of sectors having sequentially adjacent physical block addresses. In the sequential command processing mode, commands in the stream are performed in an order in which the commands are received by the target device.

In accordance with an embodiment, the target device may be a disc drive (such as 100) having an ATA interface that receives the commands issued by the host computer. In an embodiment wherein the target device is a disc drive the evaluating step may include receiving (such as in operation 408) a first command in the stream and receiving (such as in operation 408) a second command in the stream. The evaluating step thereafter includes comparing (such as in operation 410) physical block addresses associated with the second command to physical block addresses associated with the first command to determine whether the first command and the second command request access to sequentially adjacent groups of sectors on a disc (such as 108) of the disc drive.

In accordance with another embodiment, the operating step may include pausing (such as in operation 502) certain communications between the host computer and the target device such that the host computer is unable to issue new commands to the target device. In this embodiment, the operating step may include executing (such as in operation 506) all commands remaining in the queue after communications between the host computer and the target device are paused. The operating step may also include resuming (such as in operation 510) communications between the host computer and the target device such that the commands in the stream issued by the host computer and received by the target device in an order predetermined by the host computer. Further, the operating step further includes executing (such as in operation 516) each command in the stream in the predetermined order.

In accordance with another embodiment, the present invention may be viewed as a computer-readable program storage device which tangibly embodies a program of instructions executable by a computer system for managing queuing operations of a target device (such as 100) in accordance with an embodiment of the present invention. Therefore, each of the above-described operations and implementations may be performed by a program storage device readable by a computer system tangibly embodying a program of instructions executable by the computer system to perform the above-described method (300).

In accordance with yet another embodiment, the present invention may be viewed as a disc drive (100) having a data storage disc (such as 108) with a track of sequentially arranged data sectors located thereon, wherein commands requesting access to the disc are issued by a host computer (such as 140) and transmitted to the disc drive for performance of the commands by the disc drive. The disc drive includes a queue (such as 162) that receives and stores the commands such that the commands may be arranged in an order in which the commands are to be performed by the disc drive. The disc drive also includes a means (such as 164 and module 306) for detecting a sequential command stream containing commands that request access to groups of sectors having sequentially adjacent physical block addresses.

In accordance with an embodiment, the disc drive may further comprise a means (such as module 500) for operating the disc drive in a sequential command processing mode if the detecting means detects a sequential command stream. In this embodiment, the operating means may include a means for pausing (such as module 502) certain communications between the host computer and the target device such that the host computer is unable to issue new commands to the target device. The operating means may further include a means (such as in module 510) for resuming communications between the host computer and the disc drive such that the commands issued by the host computer and received by the disc drive in an order predetermined by the host computer. The operating means in this embodiment further includes a means (such as module 512) for executing each command in the stream in the predetermined order. In accordance with an embodiment, the commands issued by the host computer are received by an ATA interface on the disc drive.

In accordance with another embodiment, the present invention may be viewed as a method (such as in operation 300) for controlling queuing operations in a disc drive (such as 100). The method includes receiving (such as in operation 304) commands issued by a host computer (such as 140) and evaluating (such as in operation 306) the commands issued by the host computer to detect whether a sequential command stream is contained in the commands. A sequential command stream is a group of commands that request access to groups of sectors having sequentially adjacent physical block addresses. The method also includes performing the groups of commands in the sequential stream in an order that the commands of the group are received if a sequential command stream is detected by the evaluating step.

In accordance with an embodiment, the method may include performing (such as in operation 600) queuing operations in the disc drive such that the commands are placed in a queue (such as 162) once received if a sequential command stream is not detected by the evaluating step. In this embodiment, the performing step may include re-ordering (such as in operation 606) the commands as the commands in the queue to establish a re-ordered arrangement in which the commands are to be performed. The performing step may also include checking (such as in operation 608) the re-ordered arrangement of commands for overlap conditions in accordance with this embodiment. As such, the performing step may include re-ordering (such as in operation 610) the commands if an overlap condition is found in the re-ordered arrangement.

In accordance with another embodiment, the present invention may be viewed as a computer-readable program storage device which tangibly embodies a program of instructions executable by a computer system for controlling queuing operations in a disc drive (such as 100) in accordance with an embodiment of the present invention.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For instance, the target device, although described in the Detailed Description as a disc drive 100, may be any type of device operable to communicate with a host computer 140 using an industry standard protocol. For example, the target device may be a tape drive, an optical drive, a zip drive, etc. Indeed, numerous other changes may be made which will readily suggest themselves to those skilled in the art and which are encompassed in the spirit of the invention disclosed and as defined in the appended claims.

What is claimed is:

1. A method for managing queuing operations of a target device receiving commands issued by a host computer to be performed by the target device, the method comprising steps of:
(a) evaluating a stream of commands to determine whether the commands in the stream request access to two or more sequentially adjacent groups of sectors; and
(b) if the commands in the stream request access to two or more sequentially adjacent groups of sectors, operating the target device in a sequential command processing mode wherein commands in the stream are performed in an order in which the commands are received by the target device.

2. The method of claim 1, wherein the target device is a disc drive.

3. The method of claim 2, wherein commands issued by the host computer are received by an Advanced Technology Attachment (ATA) interface in the disc drive.

4. The method of claim 2, wherein the evaluating step (a) comprises:
(a)(i) receiving a first command in the stream;
(a)(ii) receiving a second command in the stream; and
(a)(iii) comparing physical block addresses associated with the second command to physical block addresses associated with the first command to determine whether the first command and the second command request access to two or more sequentially adjacent groups of sectors on a disc in the disc drive.

5. The method of claim 1, wherein the stream of commands is placed in a queue in the target device.

6. The method of claim 5, wherein the operating step (b) comprises:
(b)(i) pausing initiation of new commands between the host computer and the target device such that the host computer is unable to issue new commands to the target device; and
(b)(ii) executing all commands remaining in the queue while initiation of new commands between the host computer and the target device are paused.

7. The method of claim 6, wherein the operating step (b) comprises:
(b)(iv) resuming communications between the host computer and the target device such that the commands in the stream issued by the host computer are received by the target device in an order predetermined by the host computer; and
(b)(v) executing each command in the stream in the predetermined order.

8. A program storage device readable by a computer system tangibly embodying a program of instructions executable by the computer system to perform the method of claim 1.

9. The method of claim 1, wherein the two or more sequentially adjacent groups of sectors are set as a predetermined number of sequentially adjacent groups of sectors.

10. A disc drive having a data storage disc with a track of sequentially arranged data sectors located thereon, wherein commands requesting access to the disc are issued by a host computer and transmitted to the disc drive for performance of the commands by the disc drive, the disc drive comprising:
a queue receiving and storing the commands for arrangement of an order in which the commands are to be performed by the disc drive; and
means for detecting a sequential command stream containing commands that request access to groups of sectors having sequentially adjacent physical block addresses.

11. The disc drive of claim 10, further comprising:
means for operating the disc drive in a sequential command processing mode if the detecting means detects a sequential command stream.

12. The disc drive of claim 11, wherein the operating means comprises:
means for pausing communications between the host computer and the disc drive such that the host computer is unable to issue new commands to the disc drive.

13. The disc drive of claim 12, wherein the operating means comprises:
means for executing all commands remaining in the queue while initiation of new commands between the host computer and the disc drive is paused.

14. The disc drive of claim 13, wherein the operating means further comprises:
means for resuming initiation of new commands between the host computer and the disc drive such that the commands issued by the host computer are received by the disc drive in an order predetermined by the host computer.

15. The disc drive of claim 14, wherein the operating means further comprises:
means for executing each command in the stream in the predetermined order.

16. The disc drive of claim 10, wherein commands issued by the host computer are received by an Advanced Technology Attachment (ATA) interface in the disc drive.

17. A method for controlling queuing operations in a disc drive wherein commands are re-ordered prior to being performed by the disc drive, the method comprising steps of:
(a) receiving commands issued by a host computer;
(b) evaluating the commands issued by the host computer to detect whether a sequential command stream is contained in the commands, wherein the sequential command stream is a group of commands that request access to two or more sequentially adjacent groups of sectors; and
(c) if a sequential command stream is detected by the evaluating step (b), disabling reordering operations such that the two or more sequentially adjacent group of commands of the sequential command stream may be performed in an order that the commands of the group are received by the receiving step (a).

18. The method of claim 17, further comprising:
(d) if a sequential command stream is not detected by the evaluating step (b), maintaining queuing operations in the disc drive such that the commands are placed in a queue once received by the receiving step (a).

19. The method of claim 18, wherein the maintaining step (d) comprises:
(d)(i) re-ordering the commands as the commands are present in the queue to establish a re-ordered arrangement in which the commands are to be performed.

20. The method of claim 19, wherein the maintaining step (d) further comprises:
(d)(ii) checking the re-ordered arrangement of commands for overlap conditions.

21. The method of claim 20, wherein the maintaining step (b) further comprises:
(d)(iii) re-ordering the commands if an overlap condition is found in the re-ordered arrangement.

22. A program storage device readable by a computer system tangibly embodying a program of instructions executable by the computer system to perform the method of claim 17.

23. The method of claim 17, wherein the receiving step (a) comprises receiving the commands issued by the host using an Advanced Technology Attachment (ATA) interface in the disc drive.
